(19) United States
(12) Patent Application Publication
(10) Pub. No.: US 2025/0028192 A1
(43) Pub. Date: Jan. 23, 2025

(54) EYEWEAR MANIPULATION DEVICE

(71) Applicant: Bruce Rubin, Voorhees, NJ (US)

(72) Inventor: Bruce Rubin, Voorhees, NJ (US)

(21) Appl. No.: 18/778,096

(22) Filed: Jul. 19, 2024

Related U.S. Application Data
(60) Provisional application No. 63/514,461, filed on Jul. 19, 2023.

(51) Int. Cl. G02C 13/00

(52) U.S. Cl. CPC G02C 13/001

(57) ABSTRACT

An eyewear manipulation device (aka optician bench nut) is disclosed that allows a user to brace an eyeglass frame with the user's hands, effectively clamping the frame to the device in various positions. Embodiments of the optician bench nut may be formed by injection molding, die cutting, or milling and include at least one feature (e.g., rabbeted edge, protrusion, groove) on the device's non-circular interior surface.

### CROSS-REFERENCE TO RELATED APPLICATIONS

This application claims the benefit of the filing date of U.S. provisional application no. 63/514,461, filed on Jul. 19, 2023, the teachings of which are incorporated herein by reference in their entirety.

### FIELD OF THE DISCLOSURE

The present disclosure relates generally to optician tools that facilitate work performed on eyewear, such as corrective glasses or sunglasses, and in particular, tools that facilitate safe, secure installation and removal of fasteners on eyewear frames.

### BACKGROUND

Opticians and other individuals who repair, maintain, design, assemble, or disassemble eyewear are frequently required to remove and install small fasteners (e.g., screws, rods, bolts) using correspondingly small tools. Small fastener removal and installation tools, such as a small screwdriver or adjustment pliers, often include sharp pointed ends and require, at times, substantial forces.

For repairs, adjustments, and realignments (e.g., of bridges, temples, temple tips, lenses), traditionally, a bench block is used, or opticians may use the end of the table, placing the frame of the glasses on the edge of the block or table and applying forces that risked scraping the frames or lenses, or injuring the optician.

Installation and removal of fasteners with small screwdrivers and higher pressures on fasteners, eyeglass screws, and other components of eyeglasses present a risk of injury to opticians and other professionals that work with eyewear. Due to the pressures and accuracy required, it is common for opticians to inadvertently strike or stab their hands, fingers, or objects with small fastener tools when installing or removing screws. Specifically, when an optician is using the optician's own hands to alter or fix an element on eyewear, the force is applied with a screwdriver or adjustment pliers. When a slip occurs, the optician may gouge their own hand or finger, or harm the frames, lenses, or other object. Slipping is common whether for adjusting frame screws, nose pads, or other features.

Further, opticians and relevant professionals require stability to finely adjust eyewear for an individual customer. Customers require different fittings, and due to everyday life, eyewear can sometimes become disjointed or incorrectly arranged with respect to positioning on a wearer's head.

To address the drawbacks and risks of using small fastener removal and installation tools, and to improve the stability and composition of eyewear, there is a need for an eyewear manipulation device that allows opticians to brace eyewear, to allow for a better degree of control with the optician's hands, and to allow for tolerance for bracing eyewear in various positions for removal, alignment, or installation of various fasteners or other parts.

### SUMMARY

Certain embodiments of the present disclosure are eyeware manipulation devices, referred to herein as “optician bench nuts” or “bench nuts”, for affixing, adjusting, aligning, clamping, manipulating, and controlling eyewear and other objects while providing leverage, superior positioning assistance, grippiness, and an appropriate shape for professionals to employ. Embodiments come in varying parameters of shape, size, and the nodules and notches. By using an embodiment of the disclosure, a user may improve effectiveness and may reduce risks of injury or property damage when manipulating lenses, applying screws to the frame, or applying pressure to align the end piece, the hinge, temple tip, bridge, nose pad, eye rim, or other elements of eyewear.

The present disclosure discloses a partially pliable, stable, bench nut device designed for use by opticians in holding and working on eyewear and constructed from, for example (without limitation) thick rubber, for example, nitrile with a material hardness of 60A. Certain embodiments provide a balance of firmness while also providing requisite nodules, length, width, and size for ease of use. Certain embodiments feature variable wall thicknesses to accommodate different sizes and types of glasses, allowing for an offset center that can be selected based on the specific dimensions and makeup of the glasses. Incorporated into certain embodiments are notches and grooves, including optional radius grooves and V-grooves, to enhance their functionality. The walls of the bench nut can be tapered, and an extrusion process can achieve an offset center to suit various applications. The width of the bench nut is designed to prevent injury, ensuring that the distance from the top edge to the opposing edge is sufficient to prevent a slipped screwdriver from reaching the hand holding the bench nut. The bench nut may include a lip or multiple lips on the inner wall. Serving as both an element for clamping and a holding jig, certain embodiments provide a firm and grippy surface to securely hold glasses during repair or adjustment.

Embodiments can have different bridge sizes and can be modified with an offset center to fit various designs. Embodiments may include a radial notch, a z-groove on the left side of the inner wall, an outer notch, or other elements to enhance locking capability. This may be useful for manipulation of eyeglasses, for example, manipulating temple-side elements, or for providing additional stability and security during alignment.

Some embodiments may be produced through extrusion or molding processes, allowing for versatility in manufacturing and ensuring the product meets the specific needs of opticians. Embodiments provide a versatile, safe, and effective tool for opticians to handle various glasses, ensuring a secure hold and minimizing the risk of injury.

### BRIEF DESCRIPTION OF THE DRAWINGS

FIG. 1 discloses a perspective view of an embodiment of the disclosure with the eye rim of a pair of glasses held within the inner diameter.

FIG. 1A discloses a perspective view of an embodiment of the disclosure.

FIG. 1B discloses a top-down view of the embodiment of FIG. 1A.

FIG. 1C discloses a side view of an embodiment of the disclosure.

FIG. 2 discloses a perspective view of an embodiment of the disclosure.

FIG. 3 discloses a perspective view of an embodiment of the disclosure.

FIG. 4 discloses a perspective view of a portion of an embodiment of the disclosure in use.

FIG. 5 discloses a perspective view of a portion of an embodiment of the disclosure in use.

FIG. 6 discloses a perspective view of an embodiment of the disclosure in use.

FIG. 7 discloses a perspective view of an embodiment of the disclosure.

FIG. 8 discloses a side view of an embodiment of the disclosure from FIG. 7.

FIG. 9 discloses a top view of an embodiment of the disclosure.

### DETAILED DESCRIPTION

Disclosed herein are certain embodiments for an eyewear manipulation device, referred to herein as an “optician bench nut”, that allows opticians to brace eyewear frames using the their hands to clamp the frames to the bench nut in various advantageous positions. The bench nut mitigates against injuries to opticians' extremities in part by allowing opticians to stabilize the eyewear frames from which fasteners are being removed or installed.

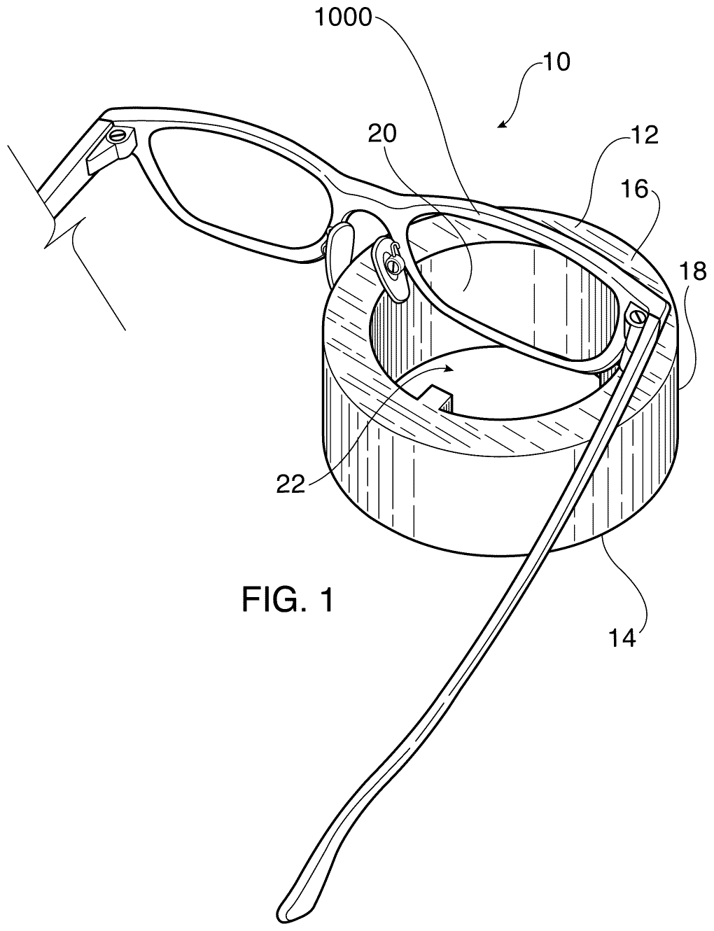

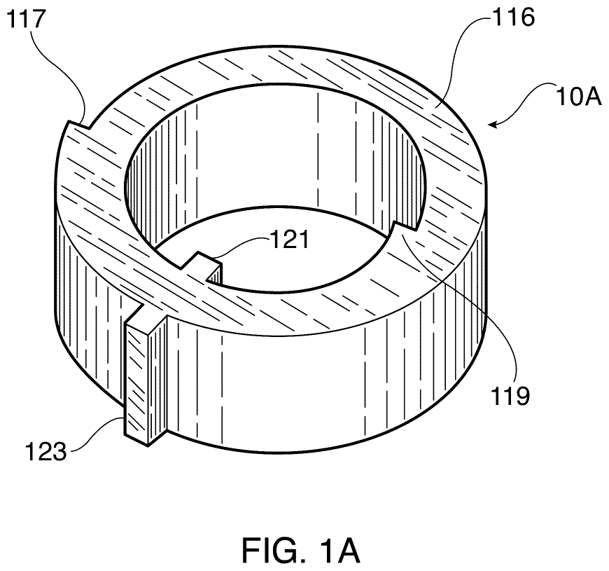

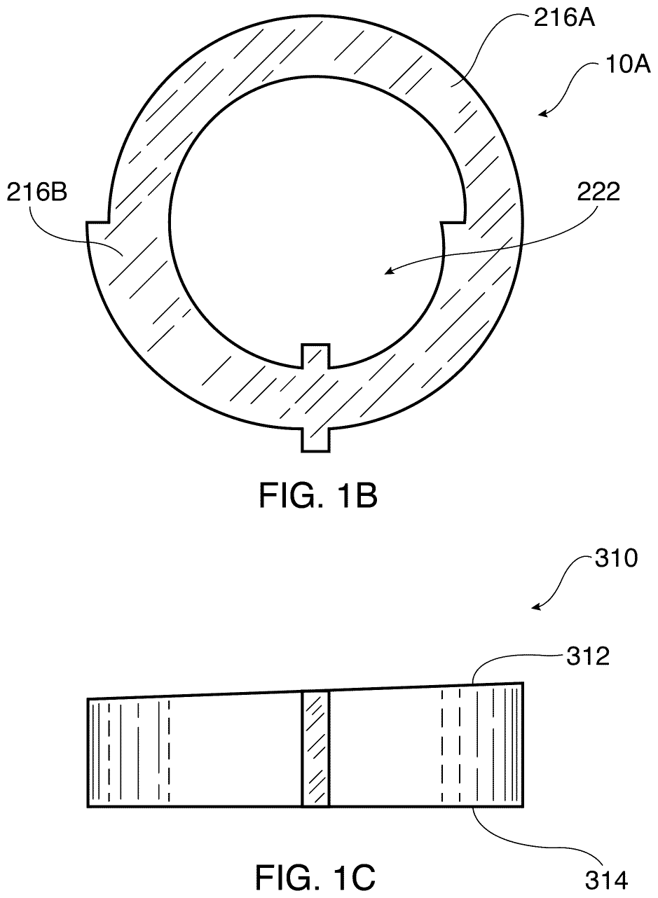

An embodiment provides a bench nut 10 that facilitates stabilization of eyewear frames when removing or installing fasteners. The optician bench nut 10 is used by opticians as an aid to more easily, safely, and securely install fasteners into, or remove fasteners from, eyewear frames. As shown in FIG. 1, the optician bench nut 10 includes: (i) a first, top working surface 12; (ii) a second, bottom working surface 14; (iii) one or more sidewalls 16 where at least part of the sidewalls extend between the top working surface 12 and the bottom working surface 14; (iv) a sidewall exterior surface 18; (iv) a sidewall interior surface 20; and (v) an interior void 22 that is at least partially defined by the sidewall interior surface 20. In other words, the sidewall 16 forms the void 22.

Referring to FIGS. 1A-1B, the material forming the optician bench nut 10A may be flexible whereby it can be rolled and configured with a sidewall 116 having a first, exterior rabbeted edge 117 and a second, interior rabbeted edge 119. In certain embodiments, the sidewall 116 can be configured to have first and second stepped or rabbeted edges 117, 119. In an alternative aspect, the material forming the optician bench nut 10A is molded to form at least one exterior rabbeted edge 117 or protrusion and at least one interior rabbeted edge 119. The bench nut 10A also has an interior protrusion 121 and an exterior protrusion 123.

The top working surface 12 as shown in FIG. 1 includes a first, top opening, and the bottom working surface 14 may have a second, bottom opening or alternatively may be closed. The top and bottom openings may be in fluid communication with each other, or not in fluid communication, where both may be in fluid communication with a void 22. In certain embodiments, the top working surface 12 or the bottom working surface 14 may optionally be closed without an opening. In certain embodiments, the bench nut 10 has a continuous sidewall 16 that defines a generally cylindrical shape, as shown in FIG. 1.

The sidewall 16 includes squared, approximately ninety-degree edges at the top where the sidewall 16 meets the top working surface 12, and squared, approximately ninety-degree edges at the bottom where the sidewall 16 meets the bottom working surface 14.

The example embodiment shown in FIG. 1 includes a top working surface 12 and a bottom working surface 14 that are both formed with a planar, substantially flat shape. The top working surface 12 and the bottom working surface 14 are substantially circular, each with an outer diameter that is about 3.5 inches, but can be, e.g., more or less than 2.5, 3.0, 4.0, or 4.5 inches. The interior void 22 is likewise approximately circular with a diameter of about 2.25 inches, but can be, e.g., more or less than 1.75, 2.0, 2.5, 2.75, or 3.0 inches. The sidewall 16 defines a “height” of the bench nut 10 that is about 2 inches, but can be, e.g., more or less than 1.0, 1.5, 2.5, or 3.0 inches.

As shown in FIG. 1, the inner void 22, bottom opening, or top opening is sized sufficiently to receive the bottom end portion of an eyeglass frame 1000. Further, the sidewall (16) thickness of the bench nut 10 is sized sufficiently to fit within a nose bridge of the eyeglass frame 1000 and/or provide a sufficient working surface to rest an edge or end piece of the frame or a portion of the temples of the frame.

In the embodiment of FIGS. 1A-1B, the interior void 222 is offset from the center of the bench nut 10A to create a variable sidewall thickness. As shown in FIG. 1B, the optician bench nut 10A has a first sidewall 216A having a first thickness, and a second sidewall 216B having a second thickness that is greater than the first thickness.

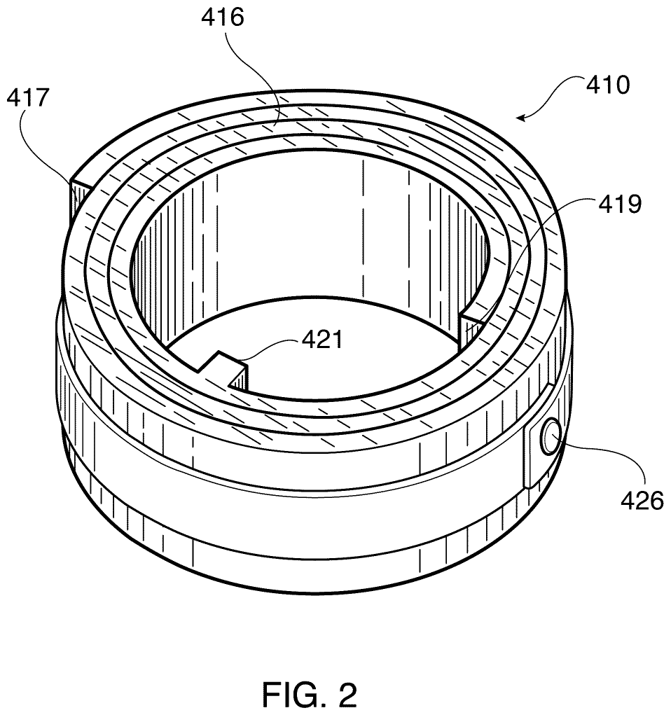

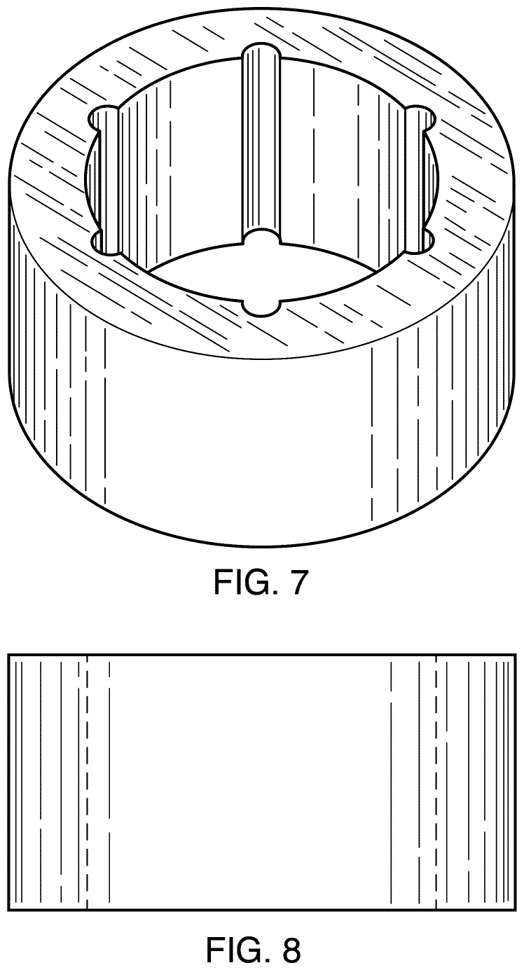

Certain embodiments may feature variable wall thicknesses, and optionally with no outer notches, allowing the device to accommodate different sizes and dimensions of glasses. This design ensures that the offset center can be adjusted depending on the specific requirements of the glasses being worked on. The walls of the bench nut may also be tapered as in bench nut 410 of FIG. 2, which can be particularly useful for accommodating different bridge sizes and shapes of glasses. For example, in another embodiment, the bench nut has a wall with a height of approximately 48 mm, a perimeter section having a width of approximately 14 mm, and an opposing perimeter section, approximately opposite the first perimeter section, having a width of approximately 17 mm. Throughout, the material may be of a thick rubber material, and may have a series of radial notches approximately evenly spaced apart (e.g., six such notches), as in the embodiment of FIG. 7. An alternative embodiment to this embodiment may include “V”-shaped notches rather than circular or radial notches.

The variable wall size allows an offset center to be chosen depending on the dimensions, size, and makeup of the glasses the optician is working on. Most embodiments will incorporate a requisite firmness and grippiness along the surface areas of the bench nut to support manipulation and control of the eyewear.

Another version of the product would be a bench nut 310 formed having an asymmetric body, as shown in FIG. 1C. The optician bench nut 310 may include atop working surface 312 that is at an angle relative to a horizontal or at an angle relative to a horizontal bottom working surface 314. The angle of the top working surface 312 relative to the horizontal bottom working surface 314 is a non-zero angle and can be, e.g., 5, 10, 15, 20, 25, 30 degrees or more.

Certain embodiments of the bench nut may incorporate elements that function as a clamping device as well as a holding jig. These elements may be coupled with a notch or groove in embodiments to make a more secure connection between the notch or groove and the pliable, flexible product material.

For certain embodiments, the height of the bench nut will reduce the risk of injury. For example, a height of approximately 48 mm will be sufficient so that, if the bench nut is held in the hand, or over a flat surface, the tool used with pressure, on a slip, will not penetrate the full height of the bench nut. This will occur because many ideal tools in the trade have a reach of less than 48 mm, or can be held and manipulated to keep the effective torque radius less than 48 mm, thereby preventing injury or damage. Put another way, the distance from the top edge 12 to the opposing bottom edge 14 will be sufficient so that, even if an optician slips, a screwdriver will not likely reach the opposing hand holding the bench nut.

Regarding the properties of the bench nut, embodiments may have a material hardness of, for example, a nitrile having a 60A medium hardness.

Regarding additional options for embodiments, the thickness of the sidewall 16 can be tapered from top to bottom, or vice versa. That is, in certain embodiments, one section of the sidewall 16 may have a width of approximately 20 mm at the base, and that same section may have a corresponding width of, for example, 14 mm or even less at the top. The effect of having these tapered walls is to allow for options of marginally greater or lesser strength, flexibility, stability, and security of grip, depending on the width at a given section and the eyewear to be engaged with. That is, with these variations in embodiments of the bench nut, the variable elements may be used by a professional to accommodate different size bridges to, where appropriate, lock the eyewear into a position.

The bench nut can be formed from any suitable durable, frictional, nonslip material, such as leather, a rubber, an elastomer, and the like. The bench nut can also include a textured surface with features such as bumps, grooves, protrusions, ridges, serrations, splines, knurling, or a combination thereof. In one exemplary embodiment, the bench nut is formed from synthetic setae made from polymers like polyimide, polypropylene, and polydimethylsiloxane. As further examples, embodiments may be constructed from thick rubber, such as nitrile, with a material hardness of 60A, which offers the necessary balance of firmness, pliability, and grip properties for use.

Such materials also allow the optician bench nut to be flexible and compressible. That is, the optician bench nut can be compressed due to the material and the presence of the void 22, which allows for a user to modify the shape of the optician bench nut from a substantially circular shape to an oval shape. As such, the optician bench nut can be configured to have a first overall shape and a second overall shape that differs from the first overall shape. Such modifications advantageously allow the optician bench nut to accommodate eyeglass frames of various shapes and sizes.

Certain embodiments can be formed from a deformable elastic material that deforms to accommodate part of the inserted eyewear frame but also expands to apply pressure and grip the eyewear frame portion within the interior void, thereby enhancing stability of the frames. Certain embodiments can be formed from a resiliently deformable material. Certain embodiments can be formed by injection molding, die cutting, milling, and the like.

In other exemplary embodiments, the optician bench nut can be formed by rolling a flat length of a suitable material, as shown in FIG. 2. FIG. 2 illustrates an alternative optician bench nut 410 formed from spirally rolling a strip of suitable material. The spiral roll layers can remain unadhered or permanently secured via an adhesive or other bonding agent or fastener (e.g., glue, epoxy, tape, etc.) to secure the spirally rolled-up strap to form a substantially cylindrical shape having exterior lip 417 and interior lip 419. As used herein, the terms “lip” and “rabbeted edge” are synonymous. Alternatively, the length of nonslip material strap can be secured in a substantially cylindrical shape with, for instance, a hose-clamp type device, rivets, or other fasteners 426 that extends around the circumference of the exterior surface or through the strap material to secure the strap in position.

In this embodiment, the rolled-up material has a thickness, e.g., 0.01, 0.10, 0.20, 0.30, 0.40, 0.50 inches or more. This material thickness provides the optician bench nut with overall sidewall thicknesses that vary or change throughout the full circumference of the optician bench nut. This is advantageous as it allows the tool to accommodate eyeglass frames of varying sizes more easily.

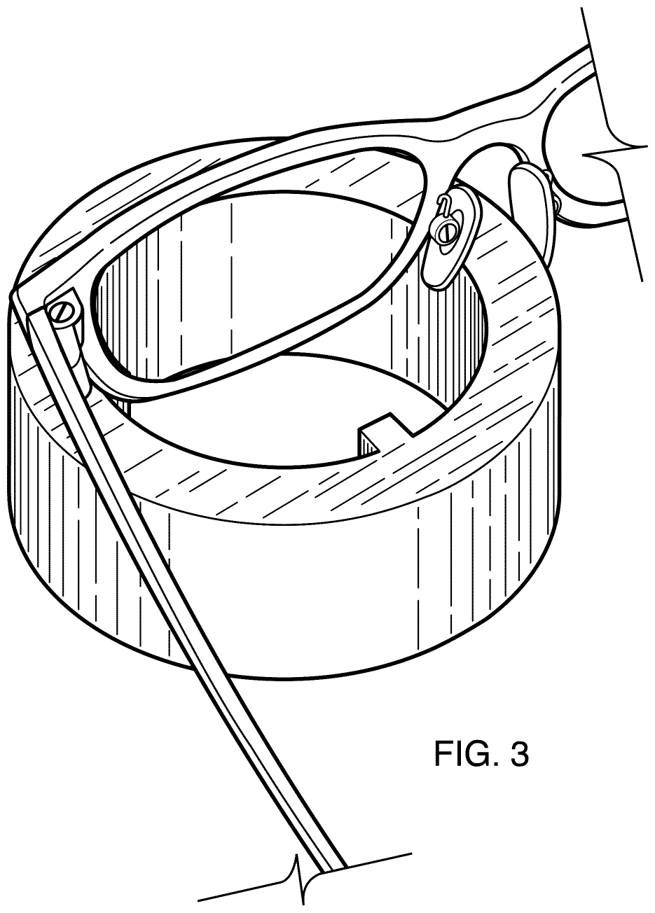

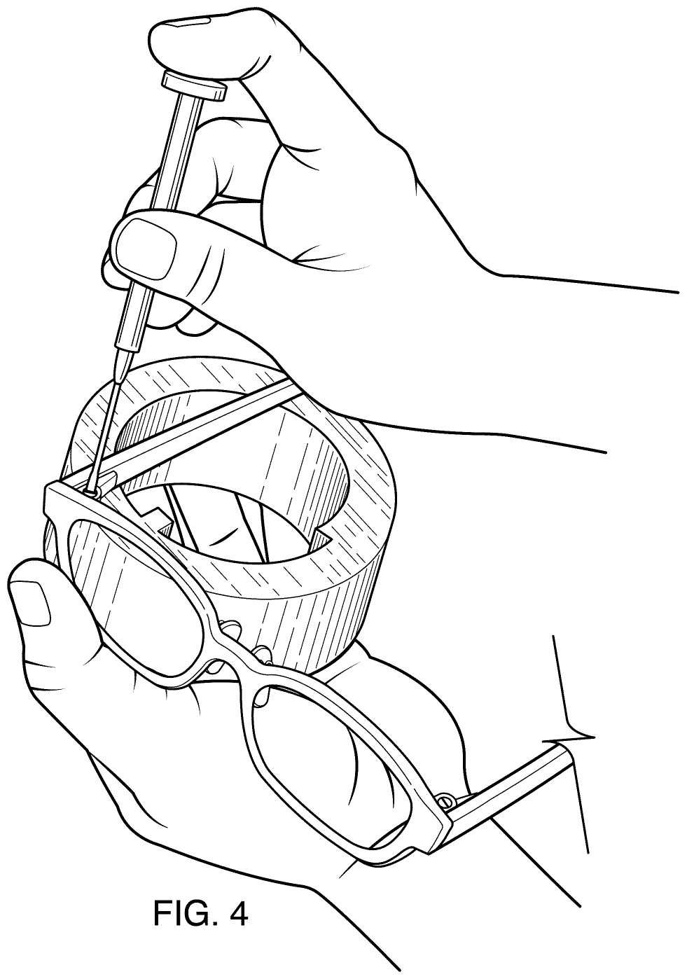

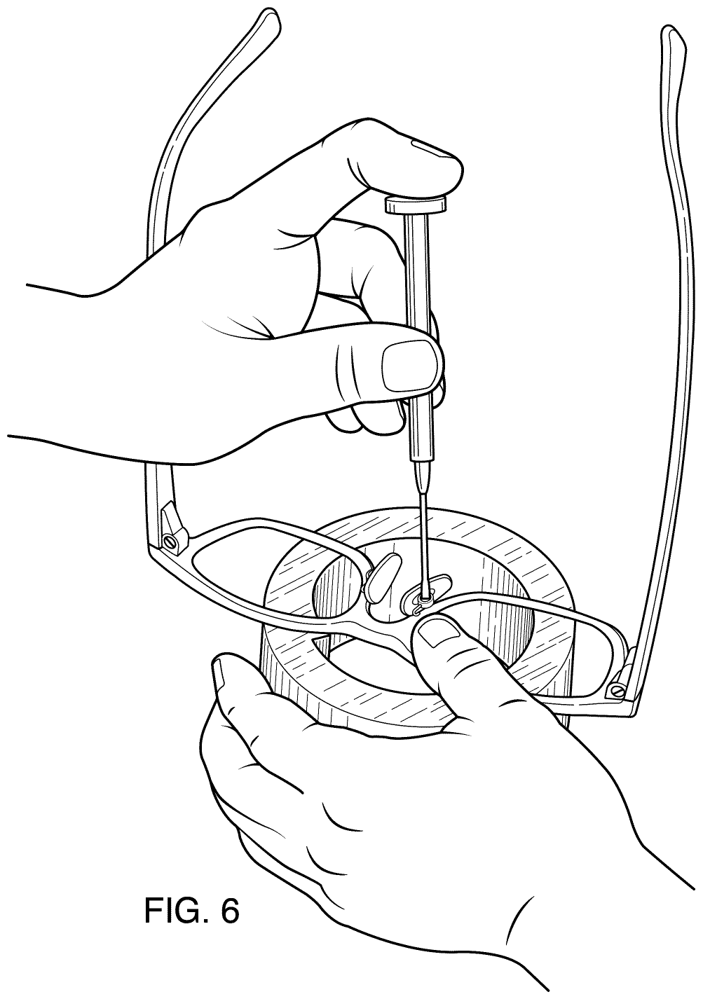

Certain embodiments of the bench nut can be used while mounted or seated on a flat surface or countertop (FIG. 3). The device can also be held by hand (FIGS. 4-6) while in use, which allows additional hand clamping techniques.

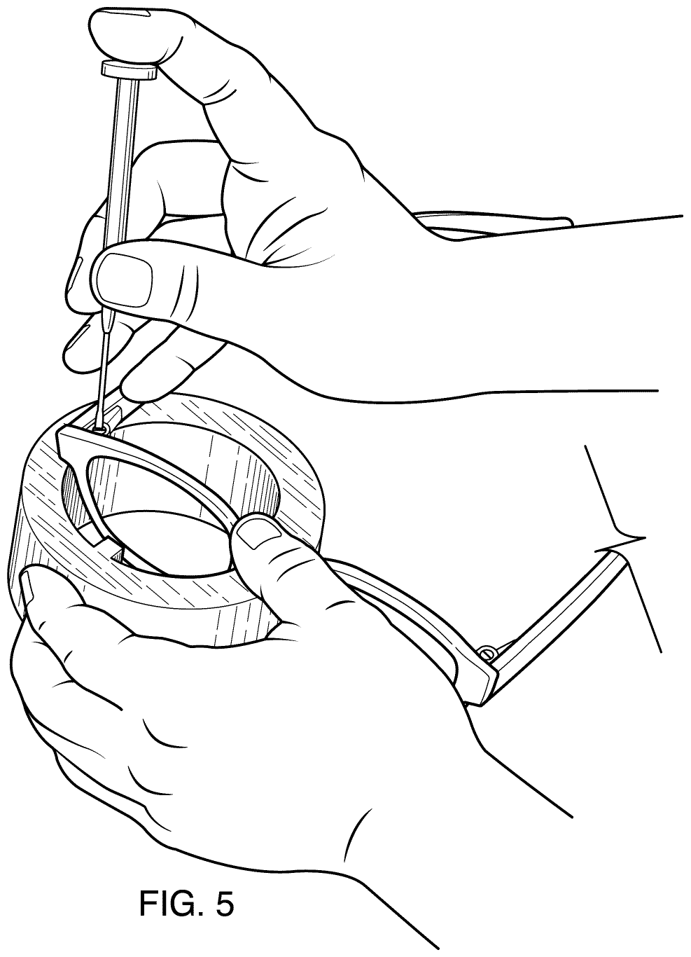

In use, certain embodiments of the bench nut allow the user to brace the eyeglass frame using their hands to “clamp” the frame to the bench nut in various positions (FIGS. 3-6). Referring to FIGS. 3 and 5, a portion of the eyewear frame surrounding one lens is seated within the interior void about the top, working surface and frictionally engages the sidewall interior surface. A user applies pressure to the top of the eyewear frame on the side that is partially seated in the interior void to hold the eyewear stable. A user can remove or install fasteners from either the side of the eyewear from partially seated within the interior void or the side of the eyewear frame outside of the interior void.

An optional feature of the bench nut includes a lip (419 of FIG. 2) on the inner wall and/or a lip (417 of FIG. 2) on the outer wall, formed by the way the material is wrapped. This lip is not necessary for all applications, but it can provide additional security in holding the glasses in place. The design can be modified with an offset center to fit various designs of glasses, ensuring compatibility with a wide range of eyewear. Versatility in embodiments is further enhanced by the possibility of producing the bench nut through extrusion or molding processes, allowing for customization to meet the specific needs of opticians.

Certain embodiments offer a flexible, secure, and safe solution for opticians. Their innovative design features, including variable wall thickness, notches and grooves, tapered walls, and optional inner wall lip, make them an essential tool for handling different types of glasses. The bench nut's ability to be produced through either extrusion or molding processes adds to its versatility, ensuring it can be tailored to the specific requirements of opticians and their diverse range of eyewear.

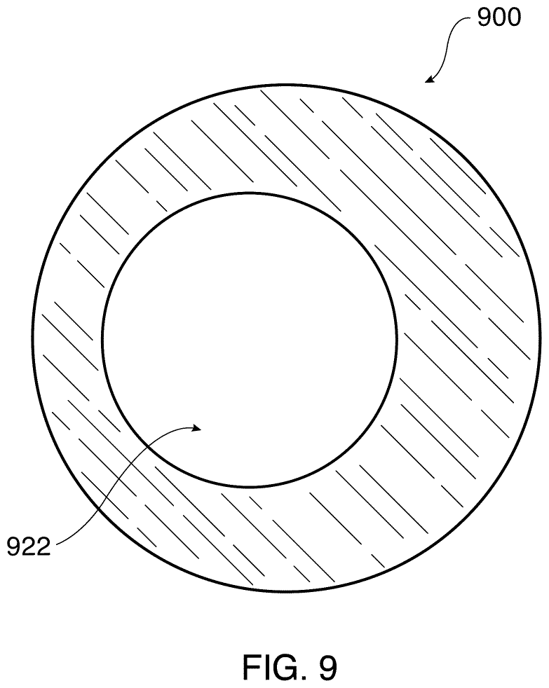

According to certain embodiments, optician bench nuts of the present disclosure have one or more of (i) at least one interior rabbeted edge, (ii) at least one exterior rabbeted edge, (iii) at least one interior protrusion, (iv) at least one exterior protrusion, (v) at least one interior groove, and/or an offset opening. For example, the bench nut 10A of FIGS. 1A-1B has an exterior rabbeted edge 117, an interior rabbeted edge 119, an interior protrusion 121, and an exterior protrusion 123, such that the bench nut 10A has a thinner sidewall portion 216A and a thicker sidewall portion 216B. The bench nut 410 of FIG. 2 has an interior rabbeted edge 419 and an (optional) interior protrusion 421, such that the thickness of the sidewall 416 is tapered around the circumference of the bench nut 410. FIG. 9 shows a bench nut 900 having an offset opening 922. In general, according to certain embodiments, an optician bench nut of the disclosure has one or more features (e.g., rabbeted edges, protrusions, grooves, offset opening, etc.) that cause the shape of the beach nut to deviate from that of a right circular hollow cylinder.

In certain embodiments, aa optician bench nut comprises (i) a sidewall defining a top surface, a bottom surface, an exterior sidewall surface, and an interior sidewall surface and (ii) a first interior feature on the interior sidewall surface that results in the interior sidewall surface (a) having a non-circular shape and/or (b) being non-concentric with the exterior sidewall surface.

In at least some of the above embodiments, the first interior feature is an interior rabbeted edge.

In at least some of the above embodiments, the optician bench nut further comprises an interior protrusion on the interior sidewall surface.

In at least some of the above embodiments, the optician bench nut further comprises an exterior protrusion on the exterior sidewall surface.

In at least some of the above embodiments, the sidewall's thickness is tapered around the bench nut's circumference.

In at least some of the above embodiments, the optician bench nut further comprises an exterior rabbeted edge on the exterior sidewall surface.

In at least some of the above embodiments, the sidewall has a thinner sidewall portion and a thicker sidewall portion.

In at least some of the above embodiments, the sidewall comprises a spirally rolled-up material.

In at least some of the above embodiments, the spirally rolled-up material forms an exterior lip and an interior lip.

In at least some of the above embodiments, the first interior feature is an interior protrusion.

In at least some of the above embodiments, the first interior feature is an interior groove.

In at least some of the above embodiments, the optician bench nut comprises a plurality of interior grooves.

In at least some of the above embodiments, the top surface defines a top plane and the bottom surface defines a bottom plane that is not parallel to the top plane.

In at least some of the above embodiments, the optician bench nut is made of an elastic material.

In at least some of the above embodiments, the top surface is open and sized to receive an eyeglass frame's bottom end portion.

In at least some of the above embodiments, the sidewall is tapered between the top surface and the bottom surface.

In at least some of the above embodiments, the interior sidewall surface is non-concentric with the exterior sidewall surface.

Certain embodiments are a method for installing or removing a fastener onto or from eyewear. The method comprises (i) supporting the eyewear on one of the above optician bench nuts and (ii) using a tool to install or remove the fastener onto or from the supported eyewear.

In at least some of the above embodiments, the method further comprises deforming the optician bench nut to support the eyewear.

In at least some of the above embodiments, the method further comprises using a first hand to hold the eyewear and the optician bench nut together while using a second hand to manipulate the tool.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject application as disclosed above.

I claim:

1. An optician bench nut comprising:
a sidewall defining a top surface, a bottom surface, an exterior sidewall surface, and an interior sidewall surface; and
a first interior feature on the interior sidewall surface that results in the interior sidewall surface (a) having a non-circular shape and/or (b) being non-concentric with the exterior sidewall surface.

2. The optician bench nut of claim 1, wherein the first interior feature is an interior rabbeted edge.

3. The optician bench nut of claim 2, further comprising an interior protrusion on the interior sidewall surface.

4. The optician bench nut of claim 3, further comprising an exterior protrusion on the exterior sidewall surface.

5. The optician bench nut of claim 2, wherein the sidewall's thickness is tapered around the bench nut's circumference.

6. The optician bench nut of claim 2, further comprising an exterior rabbeted edge on the exterior sidewall surface.

7. The optician bench nut of claim 6, wherein the sidewall has a thinner sidewall portion and a thicker sidewall portion.

8. The optician bench nut of claim 6, wherein the sidewall comprises a spirally rolled-up material.

9. The optician bench nut of claim 8, wherein the spirally rolled-up material forms an exterior lip and an interior lip.

10. The optician bench nut of claim 1, wherein the first interior feature is an interior protrusion.

11. The optician bench nut of claim 1, wherein the first interior feature is an interior groove.

12. The optician bench nut of claim 11, comprising a plurality of interior grooves.

13. The optician bench nut of claim 1, wherein the top surface defines a top plane and the bottom surface defines a bottom plane that is not parallel to the top plane.

14. The optician bench nut of claim 1, wherein the optician bench nut is made of an elastic material.

15. The optician bench nut of claim 1, wherein the top surface is open and sized to receive an eyeglass frame's bottom end portion.

16. The optician bench nut of claim 1, wherein the sidewall is tapered between the top surface and the bottom surface.

17. The optician bench nut of claim 1, wherein the interior sidewall surface is non-concentric with the exterior sidewall surface.

18. A method for installing or removing a fastener onto or from eyewear, the method comprising:
supporting the eyewear on the optician bench nut of claim 1; and
using a tool to install or remove the fastener onto or from the supported eyewear.

19. The method of claim 18, further comprising deforming the optician bench nut to support the eyewear.

20. The method of claim 18, further comprising using a first hand to hold the eyewear and the optician bench nut together while using a second hand to manipulate the tool.
